(19) United States
(12) Patent Application Publication
(10) Pub. No.: US 2025/0331512 A1
(43) Pub. Date: Oct. 30, 2025

(54) Game Lasso

(71) Applicant: Nathaniel Pena, Weslaco, TX (US)

(72) Inventor: Nathaniel Pena, Weslaco, TX (US)

(21) Appl. No.: 18/648,136

(22) Filed: Apr. 26, 2024

(51) Int. Cl. A01M 31/00

(52) U.S. Cl. CPC A01M 31/006

(57) ABSTRACT

Small game hunting is subject to conservation regulations to ensure sustainability, yet current methods lack efficiency in managing harvested animals in the field. This invention presents a wildlife harvest management system to address this gap. It enables hunters to track, carry, and limit harvested game animals in compliance with state regulations, promoting sustainable hunting practices.

### CROSS REFERENCE TO RELATED APPLICATION

This application claims priority to Provisional Application Ser. No. 63/552,906 for “The game lasso” having a filing date of Feb. 13, 2024, the disclosure of which is herein incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention, referred to as the “Game Lasso,” pertains to hunting applications and specifically addresses the need for a small game keeper/carrier/tote designed to help hunters of small game stay within conservation limits. This innovative device utilizes a unique design comprising paracords of different colors, a 3-inch carabiner with an integrated bottle cap opener, and a Spiral Hitch woven handle. The Game Lasso aids hunters in tracking and adhering to conservation regulations for small game harvesting.

### Description of Related Art

Small game hunting is a cherished outdoor activity, but its sustainability relies on effective conservation measures. State regulations dictate bag limits and harvest quotas, yet existing methods for managing harvested game animals lack efficiency. Hunters struggle to track, carry, and limit their harvests in the field, leading to concerns about over-harvesting and population decline.

Existing solutions such as manual tracking methods or rudimentary storage containers offer limited effectiveness. Hunters often rely on mental tallies or rudimentary counting methods to track their harvests, which can be prone to errors and inaccuracies. Traditional storage containers lack features to securely separate and store harvested animals, leading to cross-contamination and difficulty in adhering to bag limits.

Furthermore, the absence of a reliable limitation mechanism makes it challenging for hunters to comply with state regulations. Without a clear way to monitor their harvests in real-time, hunters' risk inadvertently exceeding bag limits, leading to legal and ethical concerns.

In summary, while state regulations aim to promote sustainable hunting practices, the lack of effective management tools hinders hunters' ability to comply with these regulations. As a result, there is a pressing need for a comprehensive wildlife harvest management system that addresses these shortcomings and facilitates compliance with conservation regulations. Small game hunting, such as dove, quail, waterfowl, pheasant, rabbits, and squirrels, is subject to conservation regulations to ensure sustainable hunting practices. Hunters need a reliable method to keep, carry, and limit the number of harvested game animals in the field, as specified by state regulations. The Game Lasso is devised to fulfill this need, providing hunters with a practical and visually distinctive tool for controlled harvesting.

### SUMMARY OF THE INVENTION

The Game Lasso is a small game keeper/carrier/tote designed to assist hunters in adhering to conservation regulations. It employs a 2-level design, with 15 paracord strands in total, separated into two length levels, and a combination of 6 shorter strands on the upper level and 9 longer strands on the lower level. A 3-inch carabiner, equipped with a large mouth and an integrated bottle cap opener, serves as the anchor point for the paracord strands. The Spiral Hitch woven handle permanently attaches the paracord strands to the carabiner. Metal stainless steel rings are attached with knots at the bottom of all 15 strands.

### DETAILED DESCRIPTION OF THE INVENTION

Using the Game Lasso prevents harvested game animals from being confined within a sealed pack or container, which restricts airflow and maintains warm temperatures. Instead, the Game Lasso enables the harvested game to be exposed, allowing air circulation to keep it cool. This is crucial because uncooled harvested game spoils at a much faster rate. Additionally, prolonged exposure to warm temperatures in the field promotes bacterial growth in the harvested animal, posing potential health risks to others upon consumption.

### Tracking and Identification:

The wildlife harvest management system includes individual tracking and identification tags on the rings for harvested game animals. Each tag is equipped with a unique identifier, allowing hunters to document the harvested animal record essential data such as species, location, and date of harvest.

### Carry and Storage:

The system comprises a specialized carrying designed to securely hold and transport harvested game animals. The ring is the locking mechanism when it is noosed with its own cord around the harvested game animal.

### Compliance Verification:

The system includes noted guidelines and regulations that enables hunters to harvest game animals, record essential data, and verify compliance with state regulations.

### BRIEF DESCRIPTION OF DRAWINGS

FIG. 1 Depicts an example of a perspective view of the invention.

FIG. 2 Depicts an example of another perspective view of the invention.

### DETAILED DESCRIPTION OF THE DRAWING

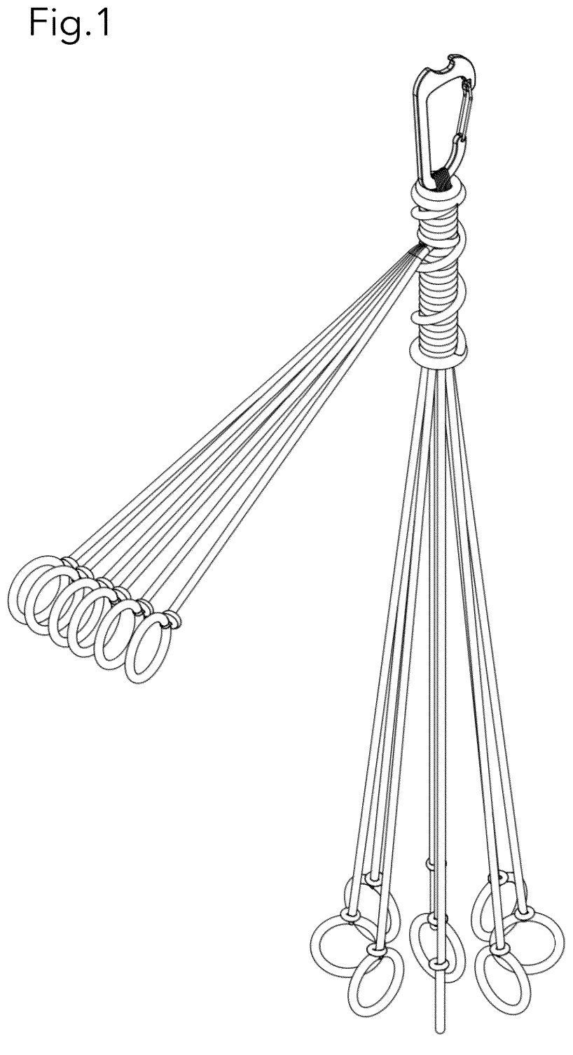

FIG. 1 illustrates an embodiment of the invention. The invention is designed with paracord strands. The Game Lasso utilizes 550 or 425 paracords of different colors. A total of 15 paracord strands are woven into the design, with 6 strands at a shorter length and 9 strands at a longer length. The invention has a 3-inch carabiner with a large mouth serves as the central anchor point for the paracord strands. The carabiner includes an integrated bottle cap opener on top for added convenience.

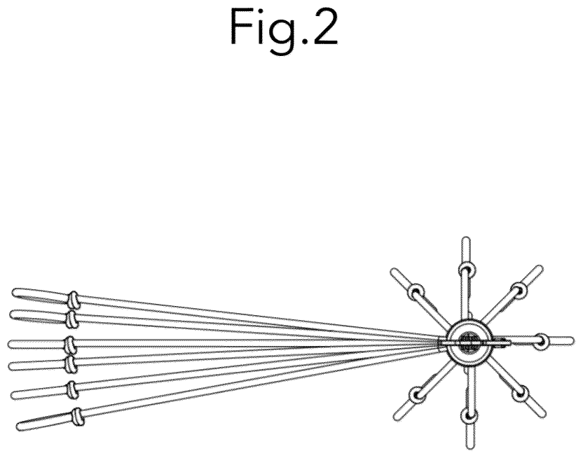

FIG. 2 Depicts an example of another perspective view of the invention. The Metal stainless steel rings are attached with knots at the bottom of all 15 paracord strands, ensuring durability and strength. Designed with a spiral hitch woven handle: The paracord strands are permanently attached to the carabiner through a Spiral Hitch woven handle.

### Operation

The Game Lasso is employed by hunters to keep, carry, and limit the number of harvested small game animals, such as dove, quail, and waterfowl. The 2-level design helps differentiate between the limits for different species, with a total of 15 rings serving as a visual and tactile indicator of the conservation regulations.

### Advantages of the Invention

Practical and visually distinctive design.
Two-level structure for separating limits on different small game species.
Controlled harvesting, keeping hunters within conservation regulations.
Integrated bottle cap opener for added convenience.

### CONCLUSION

The Game Lasso represents a novel solution for hunters engaged in small game hunting, providing a functional and visually distinctive tool to aid in controlled harvesting while staying within conservation limits. This invention addresses the need for a practical and efficient small game keeper/carrier/tote in the hunting domain.

What is claimed:

1. The wildlife harvest management system of claim 1, wherein the 3-inch carabiner serves as a secure anchor point for the paracord strands, allowing hunters to carry multiple harvested game animals with ease and convenience. 2 level strands
The wildlife harvest management system of claim 1, wherein the Spiral Hitch woven handle ensures a secure and permanent attachment of the paracord strands to the carabiner, minimizing the risk of detachment or breakage during use.
The wildlife harvest management system of claim 1, wherein the metal stainless steel rings attached to the bottom of all 15 strands provide additional reinforcement and durability, enhancing the overall strength and longevity of the Game Lasso.
A wildlife harvest management system, of claim 1, 2-level design, comprising 15 paracord strands in total, divided into two length levels. The upper level consisting of 6 shorter strands, and the lower level consisting of 9 longer strands.
